(19) United States
(12) Patent Application Publication
(10) Pub. No.: US 2002/0162784 A1
(43) Pub. Date: Nov. 7, 2002

(54) Membrane separator

(76) Inventors: Robert Kohlheb, Nienhagen (DE); Axel Muhl, Celle (DE); Zsombor Rajkai, Kazincbarcika (DE); Gerhard Braun, Overath (DE)

Correspondence Address: THE LAW FIRM OF HARRIS & BURDICK, HAROLD BURDICK AND ROBERT HARRIS, 6676 GUNPARK DRIVE, SUITE E, BOULDER, CO, 80301

(21) Appl. No.: 09/770,596

(22) Filed: Jan. 25, 2001

(30) Foreign Application Priority Data
Jan. 26, 2000 (DE) 100 03 422.5
Mar. 23, 2000 (DE) 100 14 498.5
Oct. 16, 2000 (DE) 100 51 168.6

(51) Int. Cl. B01D 63/00

(52) U.S. Cl. 210/321.6; 210/500.21

(57) ABSTRACT

The invention concerns a membrane separator for separating out low-colloidal and low-molecular contaminants as well as polyvalent ions (heavy metals) from aqueous media by means of a wound membrane element in which a corrugated distance piece (spacer) is positioned between the layers of the membrane windings. In cross-section the spacer (20, 30) has U-shaped crests (21) and troughs (22) with the legs (26) of the U-forms approximately perpendicular to the membrane surfaces (28), or triangular crests (31) and triangular troughs (32). The spacer (50) can consist of a plastic foil having a corrugated structure on both sides offset by one half-corrugation with respect to each other and where the crests (54, 54′) on both sides make contact with the layers of the membrane windings (4, 6). To increase the turbulence in the flow, the crests (56, 72) can have turbulence elements (60, 76). The membrane separator according to the invention increases the effective surface area of the membrane, minimizes the risk of fouling and reduces the volumetric flow rate.

The invention concerns a membrane separator for separating out low-colloidal and low-molecular contaminants as well as polyvalent ions (heavy metals) from aqueous media according to the preamble of claim 1 or 2.

At present there are different separating techniques such as chemical and mechanical separating methods for separating out the aforementioned contaminants.

The chemical methods mainly make use of oxidative processes in which, for example, hydrogen peroxide (H₂O₂) or ozone (O₃) are used. For a number of years membrane techniques have been increasingly used instead.

The membrane separation methods which are used here are microfiltration, ultrafiltration and nanofiltration as well as reverse osmosis. These methods are operated by pressure and are distinguished by their transmembrane pressure differences and their critical diameters.

Depending on the size of the pores and the membrane being used, microfiltration operates in a pressure range of 1-10 bar, separating out substances with a size of 0.075-5 μm, occasionally also up to 10 μm.

Ultrafiltration operates at pressures of 1-10 bar and with pore sizes of 0.005-0.2 μm.

Both filtration techniques, microfiltration and ultrafiltration, are based on membranes with pores. Water transport here is convective.

If you consider that in plan the pores of the polymer membranes are more or less circular, then for determining the retention the average molecule diameter in relation to the pore diameter is clearer than the molecular weight.

The substances separated out form a covering layer on the surface of the membrane on the feed side which acts as a secondary membrane and is crucial for the separation behaviour of the method. Therefore, as this layer grows so does the critical diameter of the membrane; so the covering layer serves as a type of a second filter. On the other hand, however, the flow of permeate is drastically reduced.

This covering layer can exhibit an equilibrium between breakdown and formation, i.e. the flow settles to a stationary final value.

As a rule, however, equilibrium is not achieved; the flow of permeate becomes less and less.

In order to prevent the flow from being reduced too severely, back-flushing with the permeate or chemical cleaning is necessary at certain intervals.

Various chemicals, stabilizers or inhibitors can be used during the separation process in order to prevent fouling and scaling in the pores.

Low-molecular constituents, colloids and substances which tend to agglomerate can clog the channels of the pores, thereby representing a major problem for the microfiltration and ultrafiltration methods. These materials become embedded in the pores and can only be removed by means of chemical cleaning if the particle causing the clogging is soluble in the cleaning agent. Other insoluble particles remain firmly adhered in the pores. Therefore, the flow of permeate drops lower and lower with the age of the filter despite regular cleaning and back-flushing.

These particulate constituents embedded in the pores can stimulate biofouling, which can have an effect on the quality of the permeate and the lifetime of the membranes.

With biological or oxidative pretreatment in particular, diminished organic molecules must be accepted. It should be noted here that porous microfilter and ultrafilter membranes cannot guarantee reliable retention of low-molecular organic constituents. Therefore, an adequate reduction of COD and BOD₅ values cannot be achieved in the case of these low-molecular organic substances (<1000 D).

The nanofiltration method makes use of membranes without pores. Here, the components to be permeated dissolve into the membrane on the feed side, diffuse through the membrane and desorb on the permeate side.

Another very important influence on the substance transport is the electrical effect on the surface of the membrane. The retention capacity is very different for monovalent and polyvalent ions owing to these negative charges at the surface of the membrane.

The negative charge at the surface of the membrane (ξpotential) means that it is essential for the pH value of the medium to be correct in order to achieve adequate permeate quality.

The pH value must be greater than 7 because at lower pH values the free H+ ions neutralize the negative charges at the membrane and thus prevent adequate retention from being achieved.

These two effects, the solution-diffusion model and the surface charge of the membrane, are combined in the nanofilter membrane.

In addition, the so-called Donnan Effect plays a major role. This says that the retention of monovalent ions decreases in the presence of and with increasing concentration of polyvalent ions and can even assume negative values.

As the nanofilter has virtually no pores, acceptable retention is achieved with respect to COD and BOD₅, especially in the case of low-molecular organic constituents.

Furthermore, it is necessary to analyse not only the membrane properties and membrane separation behaviour for different fluid media, but also the shape of the distance piece (spacer).

It is known that spiral wound elements represent a very economic modular form, particularly with the diffusive membrane separation methods (nanofiltration and reverse osmosis).

Wound elements require spacers on the feed side (and permeate side). The spacers on the feed side are available with different shapes:

diamond spacer

parallel spacer

tubular spacer (new development)

[image]

All three types of spacer have been developed and optimized for different applications. The user must carefully choose which spacer is to be used for which medium.

Diamond spacers should only be used with simple homogenous media which do not agglomerate or cause scaling (crystalline sediments), e.g. pretreated drinking water, ionogenic solutions, emulsions.

Parallel spacers are suitable for simple heterogeneous solutions. With this type of spacer a certain clouding without particulate sediments is still acceptable, e.g. controlled biology headwaters, colloidal solutions, pigments and proteins contained in solvent.

Tubular spacers are used with complex heterogeneous solutions. Concentrations of these complex media can lead to diverse sediments forming, e.g. crystalline sediments (scaling), and the agglomeration of low-particulate constituents, e.g. from industrial waste water, mother liquor for regeneration, rinsing waste water from ion exchangers, recycled water from bottle washing plants.

Fouling can occur with all three types of spacer irrespective of which form is chosen. In such cases only chemical cleaning can help or—in the case of tubular spacers having membranes without pores—rinsing with drastically increased through-flow velocities.

While the diamond and parallel spacers exert different turbulence effects due to their shape in order to bring about improved separation, the tubular spacer guarantees lower turbulence in the medium even with higher through-flow velocities. Therefore, the tubular spacer requires a higher through-flow velocity which in turn leads to a higher energy consumption. But using a tubular spacer in conjunction with a lower through-flow results in the membrane surface becoming clogged more quickly.

A compromise solution to this problem is reached by:

1. A lower through-flow for the module and hence lower energy consumption but worse clogging of the membrane during operation.

2. Periodically rinsing the individual modules briefly with a higher through-flow using a feed medium or pure water without release of permeate. This removes the clogging particles from the surface of the membrane without pores.

The use of the tubular spacer means that considerably fewer cleaning chemicals are required, thereby achieving an ecological and economic advantage.

The task of the present invention is to create a membrane separator with spiral wound elements in such a way that the effective surface area of the membrane is increased, the risk of fouling is minimized and the volumetric flow rate can be reduced.

This task is solved by the invention according to claim 1 and claim 2.

Advantageous and material further developments of the solution to the task are specified in the subclaims.

The invention is intended to be explained in more detail in the following by means of the attached drawing.

It shows

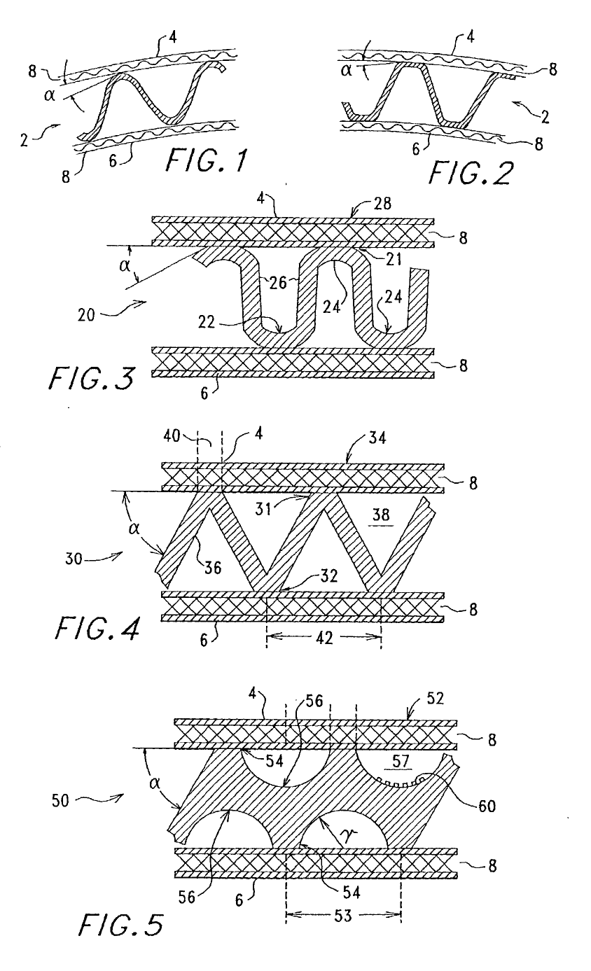

FIG. 1 a schematic part-view of a known embodiment form of a distance piece (spacer) for a spiral wound element in the no-load state;

FIG. 2 the spacer according to FIG. 1 in the state loaded by the winding pressure;

FIG. 3 a schematic part-view of a first embodiment form of a distance piece (spacer) according to the invention for a spiral wound element;

FIG. 4 a schematic part-view of a second embodiment form of a distance piece (spacer) according to the invention for a spiral wound element;

FIG. 5 a schematic part-view of a third embodiment form of a distance piece (spacer) according to the invention for a spiral wound element;

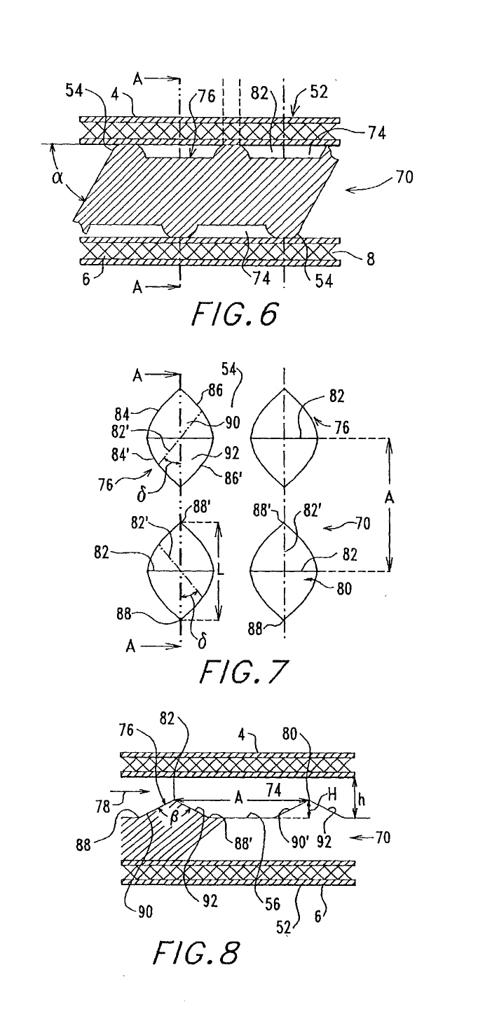

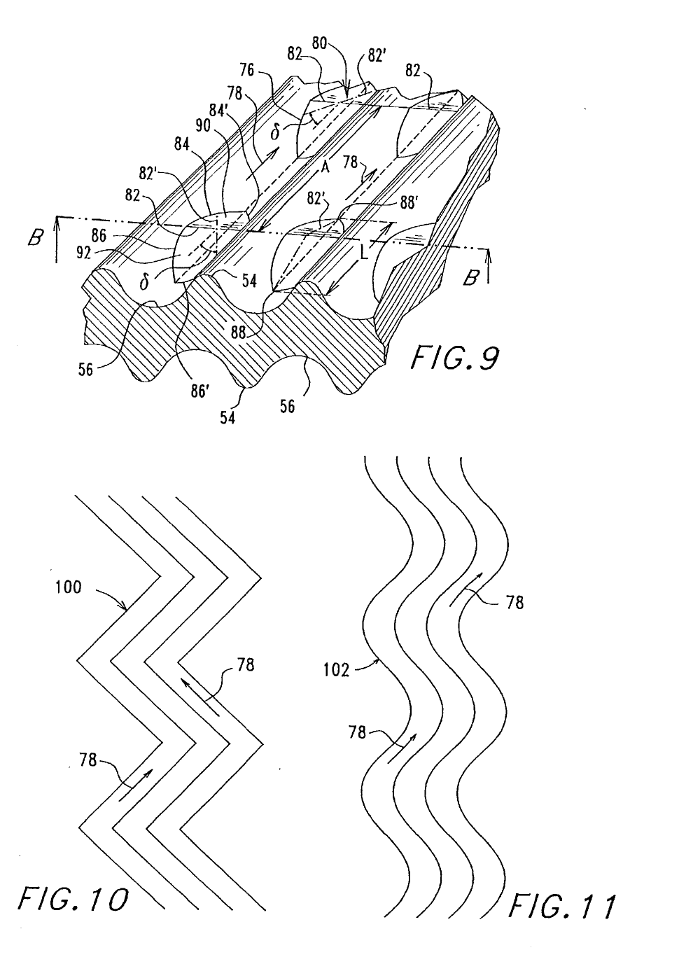

FIG. 6 a schematic part-view of a fourth embodiment form of a distance piece (spacer) according to the invention for a spiral wound element (section B-B through spacer according to FIG. 9);

FIG. 7 a plan view on the spacer according to FIG. 6;

FIG. 8 a section A-A through the spacer according to FIGS. 6 and 7;

FIG. 9 a schematic oblique view of the spacer according to FIGS. 6 to 8;

FIGS. 10 and 11 schematic plan views of two further embodiment forms of the spacer.

Identical components in the figures of the drawing have been given identical reference numbers.

FIGS. 1 and 2 show a known spacer 2 with a sine-wave form between two membrane layers 4, 6 of a wound element in the no-load state. Reference number 8 designates permeate membrane pockets. In this spacer the angle α between membrane and spacer is relatively small; this is unfavourable in terms of flow and brings with it the risk that solids can collect and raise the risk of fouling. The constant winding pressure means that in practical operation the rounded part of the spacer in contact with the membrane is flattened, cf. FIG. 2, which reduces the unobstructed effective membrane surface area and also angle α. The flow through the spacer thus deteriorates and the risk of fouling increases.

FIG. 3 shows a corrugated spacer 20 in which the crests 21 and troughs 22 have a U-shape. The U-part 24 of the crests and troughs is shaped like an arc. The legs of the U 26 between crests and troughs are approximately perpendicular to the surface of the membrane 28. This arrangement produces a larger angle a between the surface of the membrane 28 and the spacer than with the known embodiment form according to FIGS. 1 and 2. Stability is better and the flattening effect caused by the winding pressure is lower. However, the area of the membrane covered by the spacer 20 per half-corrugation is still relatively large. The flow cross-section is also relatively large, which means that the resulting volumetric flow rates are correspondingly large.

FIG. 4 shows a spacer 30 with a zigzag shape, i.e. the crests 31 and troughs 32 are triangular in shape. This results in a very large angle a, e.g. 60°, between the membrane 34 and the flanks 36, which means that the risk of contaminants adhering is virtually avoided. The risk of fouling is hence minimized. The triangular shape of the crests and troughs results in a triangular-shaped flow cross-section 38. The area of contact 40 with the membrane is very small, which results in a larger unobstructed effective membrane surface area 42. The volumetric flow rate through this spacer is also still relatively large. The spacer 30 is unfavourable in structural terms because the winding pressure could cause the flanks 36 to buckle and the spacer to collapse. This risk can be partly dealt with by choosing a suitable material thickness; material thicknesses of 0.05-0.5 mm can be used. However, the wall should not be too thick because otherwise the unobstructed effective membrane surface area is reduced too much. A beneficial distance between membrane layers 4 and 6 is, for example, about 1.016 mm.

FIG. 5 shows a spacer 50 consisting of a relatively thick plastic foil, both sides of which have identical corrugated structures arranged offset by one half-corrugation with respect to each other. The crests 54, 54′ of the corrugated structures each make contact with the membrane winding layers 4, 6. The apex angle or the radius of the crests 54, 54′ and the radius r of the, preferably, curved troughs 56 can be selected as required. The radius of the crests can be, for example, 0.2032 mm, the radius r of the troughs, for example, 0.635 mm, and the distance between membrane layers 4 and 6, for example, 1.524 mm.

This arrangement, like the embodiment form according to FIG. 4, results in a relatively small contact area between spacer 50 and membrane 52, which guarantees that a large effective membrane surface area 53 is maintained. Apart from that, this arrangement ensures that there is a large angle a, e.g. 60°, between the spacer and the membrane layers, similar to the embodiment form according to FIG. 4, so that the risk of clogging in the region of this angle and hence the risk of fouling are substantially reduced with this spacer 50 as well. The curved arrangement of the troughs 56 creates tunnel-like axial flow channels 57, whereby the radius r of the curve can be chosen from a wide range; this has the advantage that the flow cross-section can be adjusted depending on the respective media in such a way that a reduced volumetric flow rate results. This arrangement of the spacer 50 results in significantly larger wall thicknesses than with the aforementioned spacers; however, the spacer 50 is very stable and the risk of flattening of the pointed crests and the risk of buckling and collapse of the wall in this spacer is virtually eliminated. Furthermore, this arrangement has the advantage that a generous unobstructed effective membrane surface area can be maintained even with larger winding pressures.

FIGS. 6 to 9 a show a further embodiment form 70 of a spacer for a membrane wound element according to the invention. The spacer 70 differs from the spacer according to FIG. 5 in that the curved crests 56 have turbulence elements 76 comprising roof-like projections 80 arranged in succession at intervals in the direction of the flow channels 74—i.e. in the direction of the flow, see Arrow 78—for increasing the turbulence. The ridge line 82 of these projections runs from one crest 54 to the adjacent crest, transverse in flow channel 74 and to the direction of the flow 78. However, the ridge lines 82 of the projections 80 can also run at any angle δ, where 0°≦δ≦180°, to the direction of flow 78, as is shown by the chain-dot lines in FIGS. 7 and 9. This allows different turbulences to be set. The lateral curving descending edges 84, 86, 84′, 86′ converge at a point 88, 88′ at the base of the trough.

The height H of the ridge 82 above the level of the troughs 56 can be, for example, approximately ⅓-½ of the height h of the flow channel 74. The ridge spacing A between the successive projections 80 is 1-10 L, where L is the length of the projections 80 between the points 88, 88′. The roof areas 90, 92 of the projections enclose an apex angle β, selected between 60° and 160°, preferably between 110° and 120°. The angle α between membranes 52 and spacer 70 is chosen to be between 10° and 60°, which also applies to the embodiment forms according to FIGS. 4 and 5.

The distance between adjacent membrane layers 4 and 6 of the wound element can be, for example, about 2.032 mm, the ridge height H about 0.406 mm, and the height h of the flow channel 74 about 0.975 mm. The ridge spacing A between successive projections 80 can be, for example, 2.438 mm, and the length L of the projections between points 88 and 88′ about 1.626 mm.

Among the advantages of increasing the turbulence by means of turbulence elements 76 are that this enables the membranes 52 to be cleaned better and it is possible to operate with lower flow rates, which can cut the energy consumption.

In contrast to the illustrations and descriptions applying to FIGS. 1 to 9 of the drawing, the crests 21, 31, 54 and the troughs 22, 32, 56 of the corrugated structures can have a zigzag arrangement 100 or a wavy arrangement 102 instead of a straight arrangement, as is shown schematically in FIGS. 10 and 11. This enables the turbulence to be increased even further. In addition, turbulence fittings can be provided similar to the turbulence elements 76 in the embodiment form according to FIG. 9. The zigzag and wavy corrugated structures can be arranged parallel to each other (as shown) or also offset with respect to each other in the direction of the flow.

The spacers according to FIGS. 1 to 11 are made from plastic foil on calendars, which exhibit corresponding surface pockets for creating the turbulence elements 60, 76.

1. Membrane separator for separating out low-colloidal and low-molecular contaminants as well as polyvalent ions (heavy metals) from aqueous media by means of a wound membrane element in which a corrugated distance piece (spacer) is positioned between the layers of the membrane windings, characterized in that in cross-section the spacer (20, 30) has U-shaped crests (21) and troughs (22) with the legs (26) of the U-forms approximately perpendicular to the membrane surfaces (28), or triangular crests (31) and triangular troughs (32).

2. Membrane separator for separating out low-colloidal and low-molecular contaminants as well as polyvalent ions (heavy metals) from aqueous media by means of a wound membrane element in which a corrugated distance piece (spacer) is positioned between the layers of the membrane windings, characterized in that the spacer (50) is made from a plastic foil having a corrugated structure on both sides offset by one half-corrugation with respect to each other and where the crests (54, 54′) on both sides make contact with the layers of the membrane windings (4, 6).

3. Membrane separator according to claim 1 or 2, characterized in that the crests (21, 31, 54) and the troughs (22, 32, 56) of the corrugated structures are arranged with a zigzag or wavy shape.

4. Membrane separator according to claim 3, characterized in that the zigzag or wavy corrugated structures are arranged parallel or offset with respect to each other.

5. Membrane separator according to one of the claims 1 to 4, characterized in that the apex angle of the triangular crests (31) and/or troughs (32) can be specified.

6. Membrane separator according to one of the claims 2 to 4, characterized in that the apex angle or the radius of the crests (54) and/or the radius of the curved crests (56) can be specified.

7. Membrane separator according to one of the claims 1 to 6, characterized in that the troughs (22, 56, 72) have turbulence elements (60, 76) for increasing the turbulence in the flow.

8. Membrane separator according to claim 7, characterized in that the turbulence elements (76) consist of roof-like projections (80) arranged in succession at intervals in the direction of the flow channels (57, 74).

9. Membrane separator according to claim 8, characterized in that the ridge (82) of the turbulence elements (76) runs transverse to the flow channel (74) or at an angle 6, where 0°≦δ≦180°.

10. Membrane separator according to claim 9, characterized in that the ridge (82) runs from one crest (54) to the adjacent crest.

11. Membrane separator according to claim 8, 9 or 10, characterized in that the lateral curving descending edges (84, 86, 84′, 86′) of the roof-like turbulence elements (76) converge at a point (88, 88′) at the base of the trough.

12. Membrane separator according to one of the claims 8 to 11, characterized in that the height H of the ridge (82) above the level of the trough (56, 72) is approximately ⅓-½ of the height h of the flow channel (57, 74).

13. Membrane separator according to one of the claims 8 to 11, characterized in that the ridge spacing A of the successive projections (80) is 1-10 L, where L is the length of the projections (80) between the points (88, 88′).

14. Membrane separator according to one of the claims 8 to 13, characterized in that the roof areas (90, 92) of the projections (80) enclose an apex angle β of about 60° to 160°, preferably 110° to 120°.

15. Membrane separator according to one of the preceding claims, characterized in that the angle α between the membranes and the flanks of the crests is 10° to 60°.

16. Membrane separator according to one of the preceding claims, characterized in that the distance between adjacent membrane layers (4, 6) of the wound element is about 2.032 mm, the height H of the ridge (82) about 0.406 mm, and the height h of the flow channel (74) about the 0.975 mm.

17. Membrane separator according to one of the preceding claims, characterized in that the ridge spacing A between successive projections (80) is about 2.438 mm, and the length L of the projections between the points (88, 88′) about 1.626 mm.
